(19) United States
(12) Patent Application Publication
(10) Pub. No.: US 2024/0403774 A1
(43) Pub. Date: Dec. 5, 2024

(54) GREENHOUSE GAS VERIFICATION AND TRANSMISSION SYSTEM

(71) Applicants: INVENTEC (PUDONG) TECHNOLOGY CORPORATION, Shanghai (CN); INVENTEC CORPORATION, Taipei City (TW)

(72) Inventors: Wei-Chao CHEN, Taipei City (TW); Chih-Fan HSU, Taipei City (TW); Yu-Lun CHANG, Taipei City (TW); Yu-Te KU, Taipei City (TW); George Wei WANG, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 18/227,237

(22) Filed: Jul. 27, 2023

(30) Foreign Application Priority Data
May 29, 2023 (CN) 202310615557.5

(51) Int. Cl. G06Q 10/0637; G06Q 10/0635; H04L 9/32

(52) U.S. Cl. CPC G06Q 10/06375; G06Q 10/0635; H04L 9/3218

(57) ABSTRACT

A greenhouse gas verification system includes a local data verification device, an upstream data verification device, and a data weighting device. The local data verification device obtains multiple sensor data and multiple data coefficients associated with the sensor data, and calculates a total greenhouse gas quantity according to these sensor data and data coefficients. The upstream data verification device obtains a greenhouse gas value and upstream evidence associated with the greenhouse gas value, and generates a verification result according to the upstream evidence and the greenhouse gas value. When the verification result is passed, the upstream data verification device outputs the greenhouse gas values. The data weighting device receives the total greenhouse gas quantity and the greenhouse gas value, and performs weighted calculations according to the greenhouse gas value and total greenhouse gas quantity to output a greenhouse gas value vector.

### CROSS-REFERENCE TO RELATED APPLICATIONS

This non-provisional application claims priority under 35 U.S.C. § 119(a) on Patent Application No(s). 202310615557.5 filed in China on May 29, 2023, the entire contents of which are hereby incorporated by reference.

### BACKGROUND

### 1. Technical Field

The present disclosure relates to greenhouse gas verification, and more particular to a greenhouse gas verification and transmission system.

### 2. Related Art

Greenhouse gas (GHG) refers to the gas that easily absorbs solar radiation and traps solar heat in the Earth's atmosphere. If the greenhouse gases significantly increase, it may lead to global warming. As the impact of greenhouse gases on the Earth's environment intensifies, climate issues have attracted international attention, and the social responsibility of the government and enterprises for tracking and verification greenhouse gases has also gradually increased. The enterprise greenhouse gas verification is divided into three scopes. Scope 1 includes direct emissions of greenhouse gases from the enterprises, such as the greenhouse gases generated by factories. Scope 2 includes indirect emissions of greenhouse gases from the energy sources, such as the greenhouse gases generated by electricity used in factory production. Scope 3 includes greenhouse gas emissions from the transportation activities of the enterprises, upstream and downstream manufacturers, and other indirect sources.

In general, the largest portion of greenhouse gas emissions in Scope 3 comes from upstream and downstream manufacturers and product users. However, verifying the greenhouse gas footprint of these manufacturers and users is a challenging task due to the following reasons: Firstly, there is a large number of upstream and downstream manufacturers, so individually verifying their greenhouse gas emissions is time-consuming and requires a significant amount of manpower. Secondly, the total greenhouse gas quantity of each manufacturer may not necessarily be directly associated with their downstream counterparts. It needs to additionally split the total greenhouse gas quantity before transmitting thereof. Thirdly, a reliable mechanism for verifying the accuracy of transmitted emissions data is needed to prevent intentional or unintentional modifications that could lead to calculation errors in the overall emissions. Lastly, an executable system is needed to describe the behavior of greenhouse gas emissions data transmission among various manufacturers.

Therefore, there is a critical need for a rapid and reliable greenhouse gas verification system that fulfills the aforementioned four requirements, so the manpower required for verifying or correcting greenhouse gas emissions footprints can be significantly reduced.

### SUMMARY

In view of the above, the present disclosure proposes a greenhouse gas verification and transmission system that modularizes the greenhouse gas verification systems of enterprises and the transmission of greenhouse gas values between enterprises into a set of identical processes. The modularized processes eliminate the need for the transmission system to be customized for each participant, thereby significantly reducing the complexity of system design. A unified design also ensures consistency in the specifications of the data sources.

According to one or more embodiment of the present disclosure, a greenhouse gas verification system includes a local data verification device, an upstream data verification device, and a data weighting device. The local data verification device is configured to obtain a plurality of sensor data associated with greenhouse gas and a plurality of data coefficients associated with the plurality of sensor data, and calculate a total greenhouse gas quantity according to the plurality of sensor data and the plurality of data coefficients. The upstream data verification device is configured to obtain a greenhouse gas value and an upstream evidence associated with the greenhouse gas value, generate a verification result according to the upstream evidence and the greenhouse gas value, and output the greenhouse gas value when the verification result passes. The data weighting device is communicably connected to the local data verification device and the upstream data verification device for receiving the total greenhouse gas quantity and the greenhouse gas value, and configured to perform a weighted calculation according to the greenhouse gas value and the total greenhouse gas quantity to output a greenhouse gas value vector.

According to one or more embodiment of the present disclosure, a greenhouse gas verification and transmission system includes a local data verification device, an upstream data verification device, a data weighting device, a data splitting device, and a secure data transmission device. The local data verification device is configured to obtain a plurality of sensor data associated with greenhouse gas and a plurality of data coefficients associated with the plurality of sensor data, and calculate a total greenhouse gas quantity according to the plurality of sensor data and the plurality of data coefficients. The upstream data verification device is configured to obtain a greenhouse gas value and an upstream evidence associated with the greenhouse gas value, generate a verification result according to the upstream evidence and the greenhouse gas value, and output the greenhouse gas value when the verification result passes. The data weighting device is communicably connected to the local data verification device and the upstream data verification device for receiving the total greenhouse gas quantity and the greenhouse gas value, and configured to perform a weighted calculation according to the greenhouse gas value and the total greenhouse gas quantity to output a greenhouse gas value vector. The data splitting device is communicably connected to the data weighting device to receive the greenhouse gas value vector and configured to split the greenhouse gas value vector into a plurality of sets and output at least one of the plurality of sets. The secure data transmission device is communicably connected to the upstream data verification device and the data splitting device, wherein the secure data transmission device is configured to receive encrypted data and convert the encrypted data into the greenhouse gas value and the upstream evidence, and convert said at least one of the plurality of sets into another encrypted data to output.

The aforementioned context of the present disclosure and the detailed description given herein below are used to demonstrate and explain the concept and the spirit of the present application and provides the further explanation of the claim of the present application.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is an application scenario diagram of the greenhouse gas verification and transmission system according to an embodiment of the present disclosure;

FIG. 2 is an internal architecture diagram of the greenhouse gas verification and transmission system according to an embodiment of the present disclosure;

FIG. 3 is a block diagram of the greenhouse gas verification system according to the first embodiment of the present disclosure;

FIG. 4 is a block diagram of the greenhouse gas verification system according to the second embodiment of the present disclosure; and

FIG. 5 is a block diagram of the greenhouse gas verification and transmission system according to the third embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present disclosure. The following embodiments further illustrate various aspects of the present disclosure, but are not meant to limit the scope of the present disclosure.

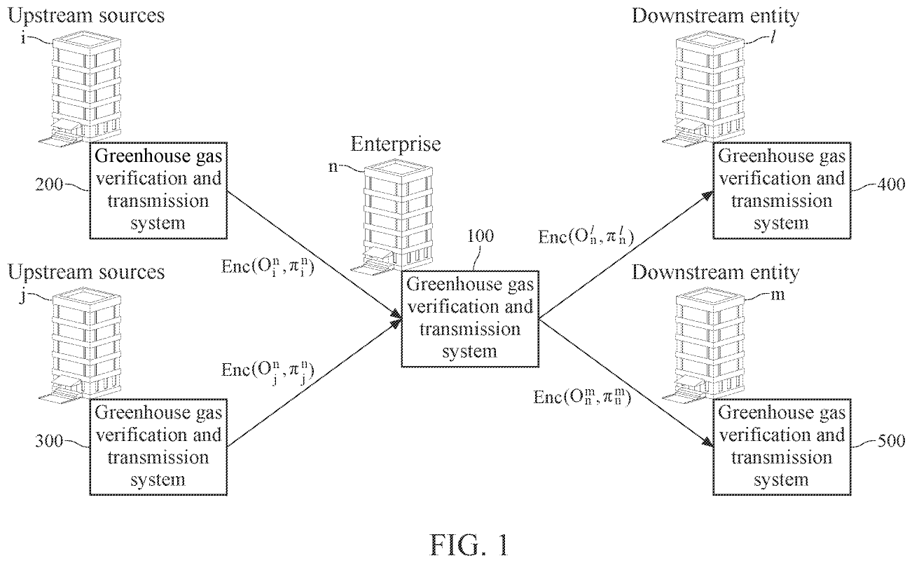

The present disclosure proposes a reliable greenhouse gas verification and transmission system adapted to businesses, factories, or any organization requiring greenhouse gas verification. FIG. 1 is an application scenario diagram of the greenhouse gas verification and transmission system according to an embodiment of the present disclosure. As shown in FIG. 1, the enterprise N has two upstream sources, i and j, as well as two downstream entities, l and m, and they are equipped with greenhouse gas verification and transmission systems 100-500 respectively. Therefore, the upstream source i and the upstream source j can encrypt and transmit the greenhouse gas verification values Oᵢⁿ and Oⱼⁿ and the corresponding evidence πᵢⁿ and πᵢⁿ to the enterprise N. The enterprise N can aggregate the values from the upstream sources i and j along with its own greenhouse gas verification values and send them to downstream entities l and m.

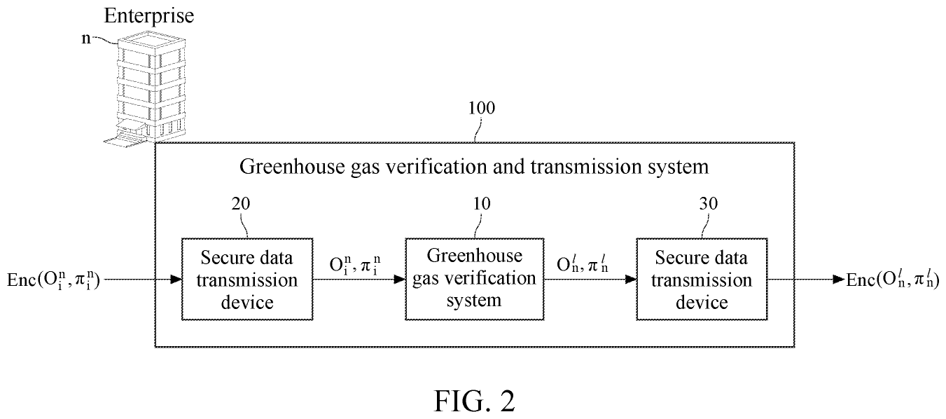

FIG. 2 is an internal architecture diagram of the greenhouse gas verification and transmission system according to an embodiment of the present disclosure. As shown in FIG. 2, the greenhouse gas verification and transmission system 100 includes a greenhouse gas verification system 10 and secure data transmission devices 20 and 30.

The secure data transmission device 20 receives the encrypted data Enc(Oᵢⁿ, πᵢⁿ) from the upstream source i and decrypts it into the greenhouse gas value Oᵢⁿ and the corresponding evidence πᵢⁿ reported by the upstream source i.

The greenhouse gas verification system 10 is communicably connected to the secure data transmission device 20 to receive the greenhouse gas value Oᵢⁿ and the evidence πᵢⁿ, and outputs the greenhouse gas values Oᵢ^{l} and the evidence πᵢ^{l} to be transmitted to downstream entity l to the secure data transmission device 30. The detailed operation of the greenhouse gas verification system 10 will be described later.

The secure data transmission device 30 is communicably connected to the greenhouse gas verification system 10 to receive the greenhouse gas values Oᵢ^{l} and the evidence πᵢ^{l}, and encrypts these data to output the encrypted data Enc(Oᵢ^{l}, πᵢ^{l}).

In an embodiment, the secure data transmission devices 20 and 30 perform the aforementioned encryption and decryption operations according to the HyperText Transfer Protocol Secure (HTTPS). However, the present disclosure is not limited thereto. Other encryption and decryption mechanisms can be adopted in practice according to specific requirements.

In summary, the upstream sources i and j of the enterprise N and the downstream entities l and m of the enterprise N all adopt the greenhouse gas verification systems 100-500 proposed in the present disclosure. This system requires that each transmitted greenhouse gas data has corresponding evidence to verify the authenticity of the data. The authenticity includes whether a legitimate calculation process has been performed and the correctness of the values. During the transmission of the values from one node to another, all the data and evidence are transmitted using secure network transmission methods to ensure that the values and evidence are not intercepted by third parties during the network transmission.

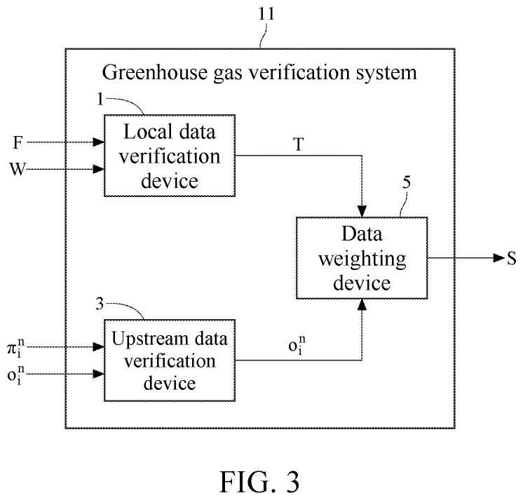

FIG. 3 to FIG. 5 are different embodiments of the greenhouse gas verification system.

FIG. 3 is a block diagram of the greenhouse gas verification system according to the first embodiment of the present disclosure. As shown in FIG. 3, the greenhouse gas verification system 10 includes a local data verification device 1, an upstream data verification device 3, and a data weighting device 5.

The local data verification device 1 is configured to calculate the total greenhouse gas quantity generated by the enterprise N. The local data verification device 1 obtains a plurality of sensor data associated with greenhouse gases and a plurality of data coefficients associated with the sensor data, and calculates the total greenhouse gas quantity according to the plurality of sensor data and the plurality of data coefficients. The sensor data may be obtained, for example, from sensors or manually input into the local data verification device 1.

In an embodiment, the sensor data includes electricity consumption and gas meter readings, but the present disclosure is not limited thereto. Any measurable values associated with devices that generate greenhouse gases (such as the quantity of fire extinguishers) can be obtained as sensor data by the local data verification device 1.

In an embodiment, the data coefficient vector is the Global Warming Potential (GWP).

In an embodiment, the local data verification device 1 calculates the total greenhouse gas quantity, which is a linear combination of the plurality of sensor data and the plurality of data coefficients, and can be represented as: T=W₁F₁+ . . . +W_{N}F_{N}, where T denotes the total greenhouse gas quantity, F={F₁, F₂, . . . , F_{N}} denotes the sensor data vector with the plurality of sensor data, W={W₁, W₂, . . . , W_{N}} denotes the data coefficient vector with the plurality of data coefficients, and N denotes the total number of elements in the data coefficient vector. However, the present disclosure does not limit the calculation of the total greenhouse gas quantity to the linear combination, the calculation of the total greenhouse gas quantity may also adopt a non-linear combination calculation method.

The upstream data verification device 3 is configured to verify the authenticity of the external greenhouse gas sources (such as upstream vendors or transporters) of the enterprise n. In an embodiment, one upstream data verification device 3 corresponds to one external greenhouse gas source. Since the enterprise n may have a plurality of external greenhouse gas sources, the present disclosure does not limit the number of the upstream data verification devices 3. The upstream data verification device 3 obtains the greenhouse gas value from the upstream source along with the upstream evidence associated with the greenhouse gas value, and generates a verification result according to the upstream evidence and the greenhouse gas value. When the verification result is successful, the upstream data verification device 3 outputs the greenhouse gas value; otherwise, it does not output anything. In other words, the upstream data verification device 3 utilizes the upstream evidence to verify the legitimacy of the data source and its calculation. The verification method follows the predefined evidence generation process. For example, when the upstream evidence adopts a digital signature, the verification method involves decrypting with the corresponding public key of that digital signature. If a zero-knowledge proof is adopted, the proof generation process involves inputting a statement into a predefined zero-knowledge proof generation module. The proof verification process involves inputting the proof generated by the algorithm into a verification module defined by an algorithm. If the output of the module is “true”, the validity of the statement is verified. Specifically, the statement is the authenticity of the greenhouse gas value and the calculation performed on them. For example, the statement T=W₁F₁+ . . . +W_{N}F_{N} can be considered as a statement to be verified.

The data weighting device 5 is responsible for integrating the values provided by the enterprise n and all external greenhouse gas sources. The data weighting device 5 is communicably connected to the local data verification device 1 and the upstream data verification device 3 to receive the total greenhouse gas quantity and greenhouse gas values. It then performs weighted calculations according to the greenhouse gas values and the total greenhouse gas quantity to output a greenhouse gas value vector. In an embodiment, the greenhouse gas value vector may be a simple numerical integration vector represented as S={T, O₁ⁿ, . . . , O_{K}ⁿ}, where S denotes the greenhouse gas value vector, T denotes the total greenhouse gas quantity, O₁ⁿ, . . . , O_{K}ⁿ denote all external greenhouse gas sources of the enterprise n, and K denotes the number of sources. In another embodiment, the greenhouse gas value vector may be a weighted vector with weight coefficients represented as S={w_{T}T, w₁O₁ⁿ, . . . , w_{K}O_{K}ⁿ}, where {w_{T}, w₁, . . . , wₖ} denote the weight coefficients. In an embodiment, the weight coefficient is the ratio between the actual amount of collected data and the expected amount of collected data. The output of the data weighting device 5 may be considered as the greenhouse gas verification result of the enterprise n.

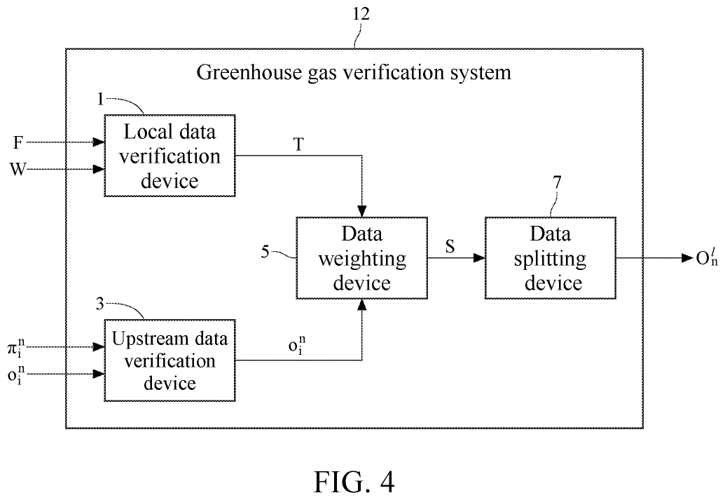

FIG. 4 is the block diagram of the greenhouse gas verification system according to the second embodiment of the present disclosure. In comparison to the first embodiment shown in FIG. 3, the second embodiment in FIG. 4 further includes a data splitting device 7, which is configured to pass the greenhouse gas verification result of the enterprise n to the downstream entity. As shown in FIG. 4, the data splitting device 7 is communicably connected to the data weighting device 5 to receive the greenhouse gas value vector and splits it into a plurality of sets, then outputs at least one of the plurality of sets.

In other words, the splitting operation of the data splitting device 7 may be represented as S=S_{secret}∪S₁ⁿ∪ . . . ∪Sₙ^{l}∪ . . . ∪Sₙ^{P}, where S_{secret} denotes the greenhouse gas value that the enterprise n wants to keep confidential (as it is not relevant to downstream entity), Sₙ^{l} denotes the value set related to the enterprise n and the downstream entity l, and P denotes the number of downstream entities. The data splitting device 7 may directly output Sₙ^{l} to the downstream entity l, i.e., Oₙ^{l}=Sₙ^{l}, or perform a numerical summation, i.e., Oₙ^{l}=Sum(Sₙ^{l}), where Oₙ^{l} denotes the output value set of the data splitting device 7, and Sum(·) denotes the function for summing vector elements.

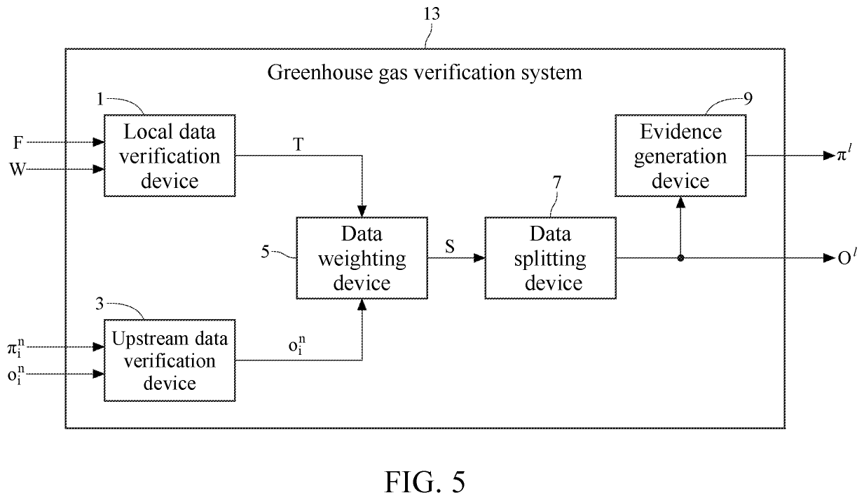

FIG. 5 is a block diagram of the greenhouse gas verification system according to the third embodiment of the present disclosure. In comparison to the second embodiment shown in FIG. 4, the third embodiment in FIG. 5 further includes an evidence generation device 9, which is configured to verify the authenticity of the value set outputted by the data splitting device 7. As shown in FIG. 5, the evidence generation device 9 is communicably connected to the data splitting device 7 to receive at least one of the plurality of sets, and generates a local evidence according to said at least one set.

In an embodiment, the evidence generation device 9 generates the local evidence according to cryptographic zero-knowledge proof verification method.

In an embodiment, the verification process of the data splitting device 7 corresponds to the evidence generation process of the evidence generation device 9. For example, when the upstream evidence is a digital signature, the evidence generation device 9 is configured to connect to a third-party certificate authority.

Please note that all devices described in the present disclosure may be implemented in either software or hardware, and the present disclosure does not limit thereof. In the embodiment that the devices are implemented in hardware, at least one of the following hardware devices may be adopted to implement the local data verification device 1, the upstream data verification device 3, the data weighting device 5, the data splitting device 7, and the evidence generation device 9: microprocessors, such as central processing units (CPUs), graphic processing units (GPUs), and/or application processors (APs); logic chips, such as field programmable gate arrays (FPGAs) and application-specific integrated circuits (ASICs). In the embodiment that the devices are implemented in software, corresponding software or application program interfaces (APIs) for each device can be implemented by writing programs according to the functions described in the present disclosure, and then installed and run on the cloud platform, servers, or personal computers of the enterprise n.

In view of the above, the reliable greenhouse gas verification and transmission system proposed by the present disclosure may significantly reduce the manpower, material, and time costs of verifying or correcting greenhouse gas emission footprints. It also provides a reliable data verification mechanism to verify the authenticity of transmitted values, avoiding malicious modifications that may result in calculation errors in the total emissions. The present disclosure modularizes the greenhouse gas verification system of enterprises and the transmission of greenhouse gas values between enterprises into a set of identical processes. These processes eliminate the need for customized systems for all participants, thus greatly reducing the complexity of system design. A unified design also ensures the consistency of data sources' specifications.

Although embodiments of the present application are disclosed as described above, they are not intended to limit the present application, and a person having ordinary skill in the art, without departing from the spirit and scope of the present application, can make some changes in the shape, structure, feature and spirit described in the scope of the present application. Therefore, the scope of the present application shall be determined by the scope of the claims.

What is claimed is:

1. A greenhouse gas verification system comprising:
a local data verification device configured to obtain a plurality of sensor data associated with greenhouse gas and a plurality of data coefficients associated with the plurality of sensor data, and calculate a total greenhouse gas quantity according to the plurality of sensor data and the plurality of data coefficients;
an upstream data verification device configured to obtain a greenhouse gas value and an upstream evidence associated with the greenhouse gas value, generate a verification result according to the upstream evidence and the greenhouse gas value, and output the greenhouse gas value when the verification result passes; and
a data weighting device communicably connected to the local data verification device and the upstream data verification device for receiving the total greenhouse gas quantity and the greenhouse gas value, and configured to perform a weighted calculation according to the greenhouse gas value and the total greenhouse gas quantity to output a greenhouse gas value vector.

2. The greenhouse gas verification system of claim 1 further comprising:
a data splitting device communicably connected to the data weighting device for receiving the greenhouse gas value vector, and configured to split the greenhouse gas value vector into a plurality of sets and output at least one of the plurality of sets.

3. The greenhouse gas verification system of claim 2 further comprising:
an evidence generation device communicably connected to the data splitting device for receiving said at least one of the plurality of sets, and generating a local evidence according to said at least one of the plurality of sets.

4. The greenhouse gas verification system of claim 3, wherein the evidence generation device is configured to generate the local evidence according to a cryptographic zero-knowledge proof verification method.

5. The greenhouse gas verification system of claim 1, wherein one of the plurality of data coefficients is a global warming potential.

6. A greenhouse gas verification and transmission system comprising:
a local data verification device configured to obtain a plurality of sensor data associated with greenhouse gas and a plurality of data coefficients associated with the plurality of sensor data, and calculate a total greenhouse gas quantity according to the plurality of sensor data and the plurality of data coefficients;
an upstream data verification device configured to obtain a greenhouse gas value and an upstream evidence associated with the greenhouse gas value, generate a verification result according to the upstream evidence and the greenhouse gas value, and output the greenhouse gas value when the verification result passes;
a data weighting device communicably connected to the local data verification device and the upstream data verification device for receiving the total greenhouse gas quantity and the greenhouse gas value, and configured to perform a weighted calculation according to the greenhouse gas value and the total greenhouse gas quantity to output a greenhouse gas value vector;
a data splitting device communicably connected to the data weighting device to receive the greenhouse gas value vector and configured to split the greenhouse gas value vector into a plurality of sets and output at least one of the plurality of sets; and
a secure data transmission device communicably connected to the upstream data verification device and the data splitting device, wherein the secure data transmission device is configured to receive encrypted data and convert the encrypted data into the greenhouse gas value and the upstream evidence, and convert said at least one of the plurality of sets into another encrypted data to output.

7. The greenhouse gas verification and transmission system of claim 6, wherein the secure data transmission device is configured to encrypt said at least one of the plurality of sets according to a hypertext transfer protocol secure.

8. The greenhouse gas verification and transmission system of claim 6 further comprising
an evidence generation device communicably connected to the data splitting device to receive said at least one of the plurality of sets, and generating a local evidence according to said at least one of the plurality of sets, and
the secure data transmission device is further configured to encrypt the local evidence and output the local evidence that is encrypted.

9. The greenhouse gas verification and transmission system of claim 8, wherein the evidence generation device is configured to generate the local evidence according to a cryptographic zero-knowledge proof verification method.

10. The greenhouse gas verification and transmission system of claim 6, wherein one of the plurality of data coefficients is a global warming potential.
